(19) United States
(12) Patent Application Publication
(10) Pub. No.: US 2026/0116682 A1
(43) Pub. Date: Apr. 30, 2026

(54) IMAGE READING APPARATUS

(71) Applicant: SEIKO EPSON CORPORATION, Tokyo (JP)

(72) Inventors: Yuhei HAMADA, SHIOJIRI-SHI (JP); Ippo HASHIMOTO, SHIMOSUWA-MACHI (JP)

(21) Appl. No.: 19/363,871

(22) Filed: Oct. 21, 2025

(30) Foreign Application Priority Data
Oct. 24, 2024 (JP) 2024-187566

(51) Int. Cl. B65H 1/14

(52) U.S. Cl. CPC B65H 1/14; B65H 2402/441

(57) ABSTRACT

An image reading apparatus includes a lower unit, an upper unit disposed above the lower unit, a hinge disposed on one side of the lower unit and the upper unit and coupling the upper unit to the lower unit in an openable and closable manner, and an assist mechanism that reduces lifting weight of the upper unit when the upper unit is shifted from a closed state to an open state. The assist mechanism includes a base portion integrally attached to the upper unit, an arm portion, a rotation shaft provided in the base portion and rotatably supporting the arm portion, an operation portion coupled to one end of the arm portion, an action portion coupled to the other end of the arm portion, and a support portion disposed in the lower unit and contacting and supporting the action portion from below.

The present application is based on, and claims priority from JP Application Serial Number 2024-187566, filed October 24, 2024, the disclosure of which is hereby incorporated by reference herein in its entirety.

### BACKGROUND

### 1. Technical Field

The present disclosure relates to an image reading apparatus.

### 2. Related Art

An example of related art of this type of apparatus is disclosed in JP-A-2014-181111.

JP-A-2014-181111 discloses a medium feeding device including a rotation unit that can be opened and closed with respect to a fixed unit.

JP-A-2014-181111 is an example of the related art.

However, since a mechanism for transporting a medium, a reading mechanism, and the like are disposed in the rotation unit, the weight is relatively large. Therefore, when a user lifts and opens the rotation unit, a heavy weight burden is applied.

### SUMMARY

In order to solve the above problem, an image reading apparatus according to the present disclosure includes: a lower unit; an upper unit disposed above the lower unit; a hinge disposed on one side of the lower unit and the upper unit and coupling the upper unit to the lower unit in an openable and closable manner; and an assist mechanism disposed on the other side opposite to the one side and configured to reduce lifting weight of the upper unit when the upper unit is shifted from a closed state to an open state, in which the assist mechanism includes: a base portion integrally attached to the upper unit; an arm portion disposed in the upper unit and extending in a rod shape; a rotation shaft being a rotation shaft provided in the base portion and rotatably supporting the arm portion at a position between one end and the other end of the arm portion; an operation portion coupled to the one end of the arm portion, extending downward, and movable in a vertical direction; an action portion coupled to the other end of the arm portion and extending downward; and a support portion disposed in the lower unit and contacting and supporting the action portion from below, and the arm portion rotates about the rotation shaft as the operation portion moves upward, and the action portion presses the support portion to lift the base portion upward, so that the upper unit is lifted upward with respect to the lower unit.

### BRIEF DESCRIPTION OF THE DRAWINGS

FIG. 1 is a front perspective view of an image reading apparatus according to a first embodiment.

FIG. 2 is a side view of the image reading apparatus according to the first embodiment.

FIG. 3 is a side view of the image reading apparatus according to the first embodiment.

FIG. 4 is a front view of a main part of the image reading apparatus according to the first embodiment.

FIG. 5 is a front view of the main part of the image reading apparatus according to the first embodiment.

FIG. 6 is a front view of a main part of an image reading apparatus according to a second embodiment.

### DESCRIPTION OF EMBODIMENTS

First, the present disclosure will be schematically described.

In order to solve the above problem, an image reading apparatus according to a first aspect of the present disclosure includes: a lower unit; an upper unit disposed above the lower unit; a hinge disposed on one side of the lower unit and the upper unit and coupling the upper unit to the lower unit in an openable and closable manner; and an assist mechanism disposed on the other side opposite to the one side and configured to reduce lifting weight of the upper unit when the upper unit is shifted from a closed state to an open state, in which the assist mechanism includes: a base portion integrally attached to the upper unit; an arm portion disposed in the upper unit and extending in a rod shape; a rotation shaft being a rotation shaft provided in the base portion and rotatably supporting the arm portion at a position between one end and the other end of the arm portion; an operation portion coupled to the one end of the arm portion, extending downward, and movable in a vertical direction; an action portion coupled to the other end of the arm portion and extending downward; and a support portion disposed in the lower unit and contacting and supporting the action portion from below, and the arm portion rotates about the rotation shaft as the operation portion moves upward, and the action portion presses the support portion to lift the base portion upward, so that the upper unit is lifted upward with respect to the lower unit.

According to the present aspect, there is provided the assist mechanism that reduces the lifting weight of the upper unit when the upper unit is shifted from the closed state to the open state. The assist mechanism includes the base portion integrally attached to the upper unit, the arm portion having a rod shape, the rotation shaft that rotatably supports the arm portion, the operation portion that is coupled to the one end of the arm portion, extends downward, and is movable in the vertical direction, the action portion that is coupled to the other end of the arm portion and extends downward, and the support portion that is disposed in the lower unit and contacts and supports the action portion from below.

Then, in the assist mechanism, the arm portion rotates about the rotation shaft as the operation portion moves upward, and the action portion presses the support portion to lift the base portion upward, so that the upper unit is lifted upward with respect to the lower unit. That is, the assist mechanism is configured to assist in lifting the upper unit upward using principle of leverage.

Accordingly, the upper unit can be lifted and opened with respect to the lower unit with small force with a simple configuration using principle of leverage.

An image reading apparatus according to a second aspect of the present disclosure is the image reading apparatus according to the first aspect, in which the upper unit includes a processing unit including a transport unit capable of transporting a medium and a first reading unit that reads an image of the medium transported by the transport unit, and when viewed from the other side to the one side, at least a part of the assist mechanism overlaps at least a part of the processing unit.

According to the present aspect, the upper unit includes the processing unit including the transport unit and the first reading unit. That is, the center of gravity of the upper unit is located closer to a portion where the processing unit is disposed. Then, the assist mechanism is disposed such that at least a part of the assist mechanism overlaps at least a part of the processing unit when viewed from the other side to the one side. Accordingly, since the assist mechanism is provided in a heavy portion of the upper unit, the effect of reducing a weight burden when opening the upper unit is large.

An image reading apparatus according to a third aspect of the present disclosure is the image reading apparatus according to the first aspect, in which the operation portion includes a long first rod portion and a force receiving portion that is located at a lower end of the first rod portion and receives lifting force, the action portion includes a long second rod portion and a pressing portion that is located at a lower end of the second rod portion and is in contact with the support portion, and the base portion includes a vertical portion having the rotation shaft at an upper portion thereof and a long horizontal portion provided at a lower portion of the vertical portion.

Note that the present aspect can be subordinate to the second aspect.

According to the present aspect, the operation portion includes the long first rod portion and the force receiving portion that is located at the lower end of the first rod portion and receives the lifting force. The action portion includes the long second rod portion and the pressing portion that is located at the lower end of the second rod portion and is in contact with the support portion. Then, the base portion includes the vertical portion having the rotation shaft at the upper portion thereof and the long horizontal portion provided at the lower portion of the vertical portion. Accordingly, the assist mechanism that enables the upper unit to be lifted upward with respect to the lower unit with small force can be realized with a simple structure.

An image reading apparatus according to a fourth aspect of the present disclosure is the image reading apparatus according to the third aspect, in which the horizontal portion includes a first penetration portion and a second penetration portion that penetrate in the vertical direction, the first rod portion is disposed to movably penetrate the first penetration portion, and the second rod portion is disposed to movably penetrate the second penetration portion.

According to the present aspect, the horizontal portion includes the first penetration portion and the second penetration portion, the first rod portion is disposed to movably penetrate the first penetration portion, and the second rod portion is disposed to movably penetrate the second penetration portion. That is, both the first rod portion and the second rod portion are provided so as to move in a state of penetrating the horizontal portion of the base portion. Accordingly, a lifting operation of the upper unit by the assist mechanism can be stably performed.

An image reading apparatus according to a fifth aspect of the present disclosure is the image reading apparatus according to the fourth aspect, in which the first penetration portion includes a first guide portion that guides movement of the first rod portion in the vertical direction, and the second penetration portion includes a second guide portion that guides movement of the second rod portion in the vertical direction.

According to the present aspect, the first penetration portion includes the first guide portion that guides movement of the first rod portion in the vertical direction. The second penetration portion includes the second guide portion that guides movement of the second rod portion in the vertical direction. Accordingly, the first rod portion and the second rod portion can be stably moved with respect to the base portion.

An image reading apparatus according to a sixth aspect of the present disclosure is the image reading apparatus according to the first aspect, further includes a restriction portion that restricts a range in which the base portion can move upward in a state where the action portion is in contact with the support portion.

Note that the present aspect can be subordinate to any one of the second aspect to the fifth aspect.

The upper unit has the largest weight load at an initial stage of an opening operation of shifting from the closed state to the open state with respect to the lower unit. After the initial stage, the load decreases.

According to the present aspect, there is provided the restriction portion that restricts a range in which the base portion can move upward in a state where the action portion is in contact with the support portion. Accordingly, it is possible to design so as to receive the assist by the assist mechanism only in the initial stage where the load of the opening operation is large. Therefore, an increase in size of the assist mechanism can be avoided.

An image reading apparatus according to a seventh aspect of the present disclosure is the image reading apparatus according to the first aspect, in which the action portion is separated from the support portion by lifting the operation portion after the upper unit is lifted via the assist mechanism.

Note that the present aspect can be subordinate to any one of the second aspect to the sixth aspect.

According to the present aspect, the action portion is configured to be separated from the support portion by lifting the operation portion after the upper unit is lifted via the assist mechanism. Accordingly, when the upper unit is in the open state, since the action portion is separated from the support portion, the upper unit does not interfere with placing the medium on the lower unit or the like.

An image reading apparatus according to an eighth aspect of the present disclosure is the image reading apparatus according to the first aspect, in which there is a gap between the action portion and the support portion in a state where the upper unit is in the closed state.

Note that the present aspect can be subordinate to any one of the second aspect to the seventh aspect.

According to the present aspect, there is a gap between the action portion and the support portion in a state where the upper unit is in the closed state. Accordingly, even when lifting force is carelessly applied to the operation portion, the upper unit can be prevented from being immediately opened by the gap. Therefore, a stable image reading operation can be realized.

An image reading apparatus according to a ninth aspect of the present disclosure is the image reading apparatus according to the first aspect, further includes an operation panel disposed on a front side, which is the other side, in which the operation portion and the operation panel do not overlap each other in a plan view.

Note that the present aspect can be subordinate to any one of the second aspect to the eighth aspect.

According to the present aspect, there is provided the operation unit disposed on the front side, which is the other side, and the operation portion and the operation panel are configured not to overlap each other in a plan view. Accordingly, the operation panel does not interfere with an operation of lifting the operation portion upward, so that the assist mechanism can be smoothly operated.

### Embodiments

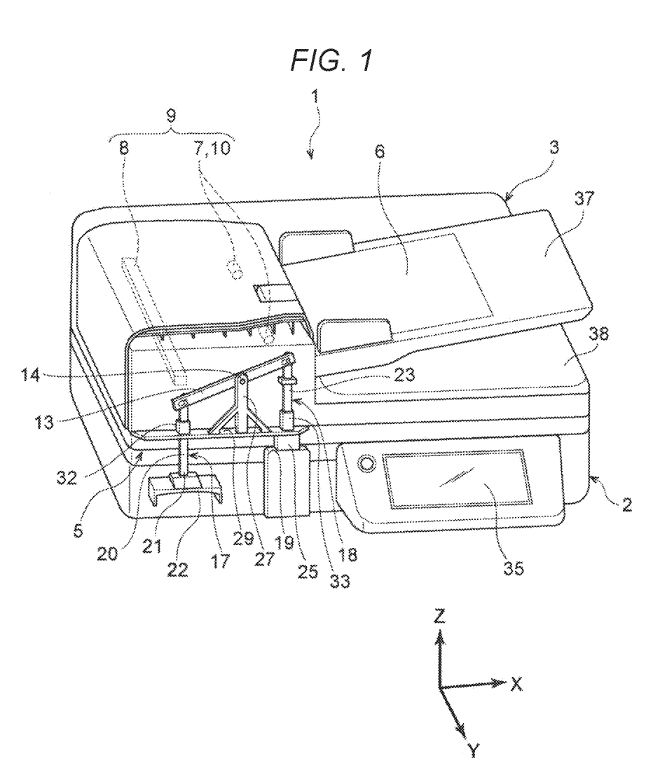

Hereinafter, an image reading apparatus according to an embodiment of the present disclosure will be specifically described with reference to FIGS. 1 to 6. Here, the image reading apparatus is a scanner.

In the following description, three axes orthogonal to one another are respectively defined as an X axis, a Y axis, and a Z axis as illustrated in the respective drawings. Directions indicated by arrows of the three axes (X, Y, and Z) are + directions of the respective directions, and the opposite directions are - directions. The Z axis direction corresponds to a vertical direction, that is, a direction in which the gravity acts, the +Z direction indicates a vertically upward direction and the -Z direction indicates a vertically downward direction. The X axis direction and the Y axis direction correspond to a horizontal direction. The + Y direction indicates a front direction of the image reading apparatus, and the - Y direction indicates a rear direction of the image reading apparatus. The + X direction indicates a right direction of the image reading apparatus, and the - X direction indicates a left direction of the image reading apparatus.

### First Embodiment

### Brief Description of Image Reading Apparatus

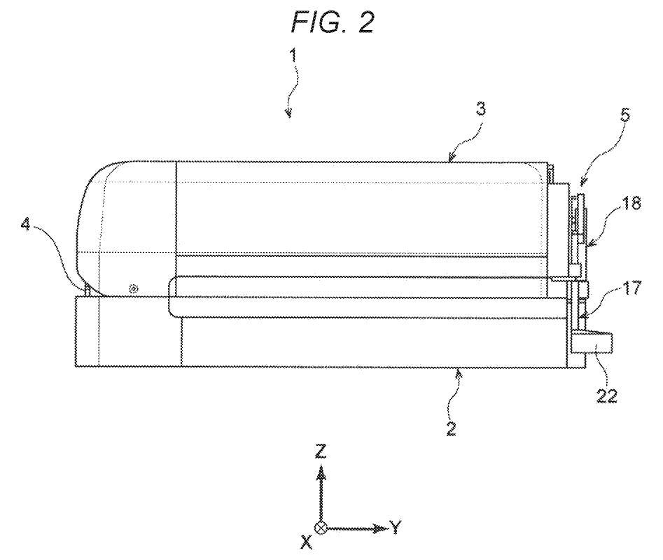

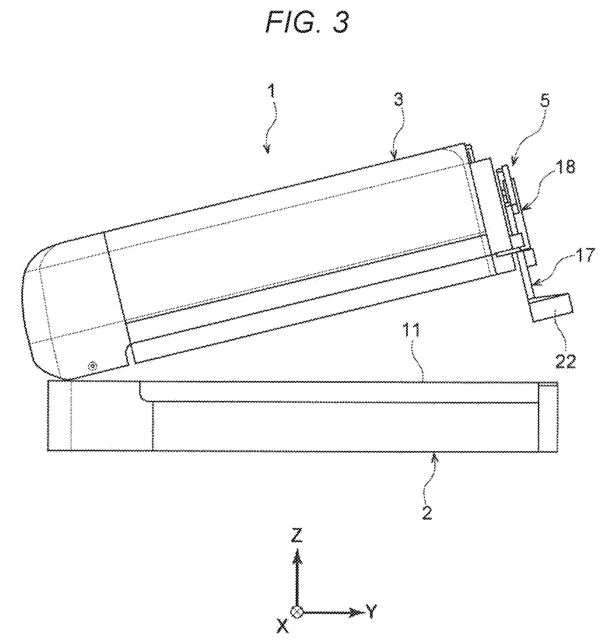

As illustrated in FIGS. 1 to 3, an image reading apparatus 1 of the present embodiment includes a lower unit 2 and an upper unit 3 disposed above the lower unit 2. The lower unit 2 and the upper unit 3 are coupled to each other via a hinge 4 on the rear side which is one side (- Y side). As illustrated in FIG. 3, the front side, which is the other end side (+ Y side) opposite to the one side (- Y side) of the upper unit 3, is openable and closable in the vertical direction with respect to the lower unit 2 with the hinge 4 as a fulcrum. FIGS. 1 and 2 illustrate the upper unit 3 in a closed state, and FIG. 3 illustrates the upper unit 3 in an open state.

Furthermore, an assist mechanism 5 is disposed on the front side of the upper unit 3. The assist mechanism 5 reduces lifting weight of the upper unit 3 when the upper unit 3 is shifted from the closed state to the open state. Details of the assist mechanism 5 will be described later.

In the present embodiment, the upper unit 3 includes a processing unit 9 including a transport unit 7 capable of transporting a medium 6 set on a setting unit 37 and a first reading unit 8 (for example, a CIS type sensor) that reads an image of the medium 6 transported by the transport unit 7. The medium 6 whose image has been read by the first reading unit 8 is discharged to a discharge unit 38. As illustrated in FIG. 1, when the upper unit 3 is viewed from the front side (+ Y side) toward the rear side (- Y side), the assist mechanism 5 is disposed such that at least part of which overlaps at least a part of the processing unit 9. In FIG. 1, in the transport unit 7, only a transport roller 10 which is a part of the component members forming the transport unit 7 is illustrated, and the other component members are not illustrated from the viewpoint of avoiding complication of the drawing.

In addition, the lower unit 2 includes a placement surface 11 (FIG. 3) on which the medium 6 can be placed, and a second reading unit (not illustrated) (for example, a CIS type sensor) that reads an image of the medium 6. The lower unit 2 has a known structure, and an image of the medium 6 placed on the placement surface 11 is read by the second reading unit. As illustrated in FIG. 1, an operation panel 35 is disposed on the front side (+ Y side) of the lower unit 2.

### Assist Mechanism

Next, the assist mechanism 5 will be described in detail with reference to FIGS. 1, 4, and 5. The assist mechanism 5 includes a base portion 12 integrally attached to the upper unit 3, an arm portion 13 disposed on the upper unit 3 and extending in a rod shape, and a rotation shaft 14 provided on the base portion 12. The rotation shaft 14 is configured to rotatably support the arm portion 13 at a position between one end 15 and the other end 16 of the arm portion 13. Here, the rotation shaft 14 is configured to be located substantially at the center between the one end 15 and the other end 16 of the arm portion 13.

An operation portion 17 is coupled to the one end 15 of the arm portion 13. The operation portion 17 extends downward (- Z direction) and is movable in the vertical direction. In the present embodiment, the operation portion 17 is disposed to be shifted in the X axis direction so as not to overlap the operation panel 35 in a plan view. An action portion 18 is coupled to the other end 16 of the arm portion 13. The action portion 18 extends downward (- Z direction) similarly to the operation portion 17. In addition, a support portion 19 is disposed in the lower unit 2. The support portion 19 is configured to contact and support the action portion 18 from below.

The assist mechanism 5 is configured to perform the following operation.

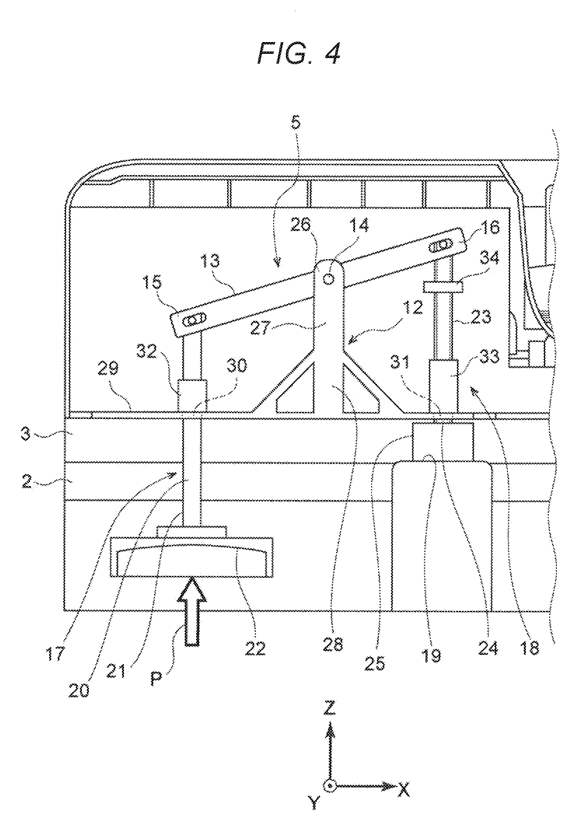

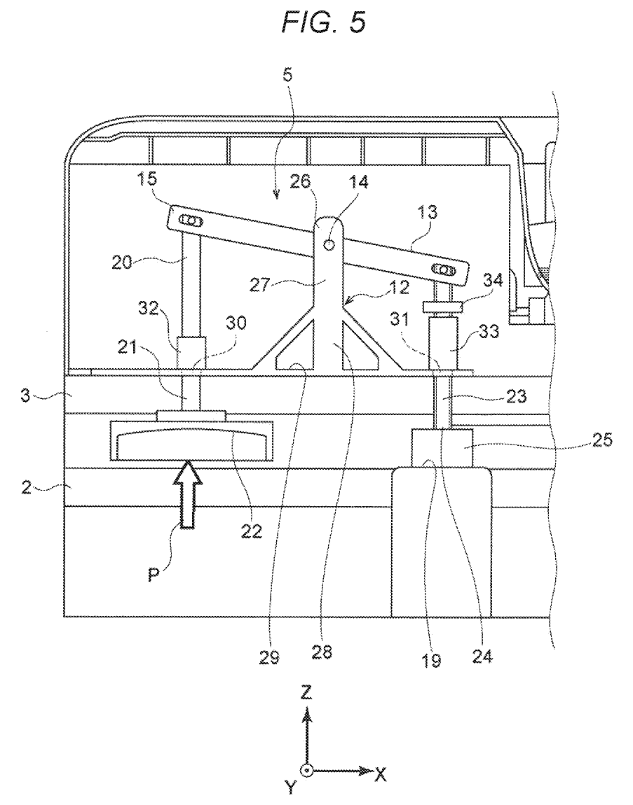

As the operation portion 17 moves upward, the arm portion 13 rotates about the rotation shaft 14. By this rotation, the action portion 18 presses the support portion 19. Then, the arm portion 13 changes from a right upward sloping state illustrated in FIG. 4 to a left upward sloping state illustrated in FIG. 5. At this time, since the action portion 18 is supported by the support portion 19 so as not to be lowered, the base portion 12 is lifted upward via the rotation shaft 14 as illustrated in FIG. 5. Accordingly, the upper unit 3 integrated with the base portion 12 is lifted upward.

That is, the assist mechanism 5 is configured to assist in lifting the upper unit 3 upward with respect to the lower unit 2.

As illustrated in FIGS. 4 and 5, in the present embodiment, the operation portion 17 includes a long first rod portion 20 and a force receiving portion 22 located at a lower end 21 of the first rod portion 20 and receives lifting force P. The action portion 18 includes a long second rod portion 23 and a pressing portion 25 that is located at a lower end 24 of the second rod portion 23 and is in contact with the support portion 19.

In addition, the base portion 12 includes a vertical portion 27 having the rotation shaft 14 at an upper portion 26 and extending along the Z axis, and a horizontal portion 29 that is provided at a lower portion 28 of the vertical portion 27 and is long along the X axis. The horizontal portion 29 includes a first penetration portion 30 and a second penetration portion 31 that penetrate in the vertical direction. Then, the first rod portion 20 is disposed to movably penetrate the first penetration portion 30. The second rod portion 23 is disposed to movably penetrate the second penetration portion 31.

The lifting force P can be made smaller as a position of the rotation shaft 14 is closer to the other end 16 rather than the center between the one end 15 and the other end 16 of the arm portion 13. That is, as the position of the rotation shaft 14 is closer to the other end 16, the reduction rate of operation force of the operation portion 17 can be increased.

In the present embodiment, furthermore, the first penetration portion 30 includes a first guide portion 32 that guides movement of the first rod portion 20 in the vertical direction. The second penetration portion 31 includes a second guide portion 33 that guides movement of the second rod portion 23 in the vertical direction. In the present embodiment, each of the first guide portion 32 and the second guide portion 33 is formed in a cylindrical shape. In addition, the first guide portion 32 is formed to be shorter in the vertical direction than the second guide portion 33, so that it is easy to lift the operation portion 17.

Furthermore, there is provided a restriction portion 34 that restricts a range in which the base portion 12 can move upward in a state where the action portion 18 is in contact with the support portion 19. Here, the restriction portion 34 is fixed to the second rod portion 23. When the base portion 12 is lifted and moved upward by the rotation of the arm portion 13 and an upper end of the second guide portion 33 comes into contact with the restriction portion 34, the upward movement of the base portion 12 is stopped. The restriction portion 34 is disposed according to the following design concept.

The upper unit 3 has the largest weight load at an initial stage of an opening operation of shifting from the closed state to the open state with respect to the lower unit 2, and the load decreases after the initial stage. It is designed to receive the assist by the assist mechanism 5 only in the initial stage where the load of the opening operation is large. Here, the restriction portion 34 is disposed such that the lifting amount of the upper unit 3 with respect to the lower unit 2 by the assist mechanism 5 is about 40 mm.

### Description of Operation of Opening Upper Unit

When the medium 6 is placed on the placement surface 11 of the lower unit 2 in the closed state of the upper unit 3 illustrated in FIGS. 1 and 4, a user applies the lifting force P upward to the force receiving portion 22 of the operation portion 17. Accordingly, the operation portion 17 moves upward, and the arm portion 13 rotates about the rotation shaft 14. At this time, since the pressing portion 25 at a lower end of the action portion 18 is in contact with the support portion 19 and the action portion 18 is supported by the support portion 19, the arm portion 13 rotates and the one end 15 of the arm portion 13 is lifted upward.

When the one end 15 of the arm portion 13 is lifted upward, the rotation shaft 14 is also lifted upward, and thus the base portion 12 is also lifted upward together. When the base portion 12 is lifted, the upper unit 3 integrated with the base portion 12 is lifted. Accordingly, the upper unit 3 shifts from the closed state to the open state with respect to the lower unit 2.

When the upper end of the second guide portion 33 comes into contact with the restriction portion 34 by the upward movement of the base portion 12, the upward movement of the base portion 12 is stopped. FIG. 5 illustrates a state immediately before the upper end of the second guide portion 33 comes into contact with the restriction portion 34.

In the present embodiment, the operation portion 17 is further lifted after the upper unit 3 is lifted by the assist of the assist mechanism 5, so that the action portion 18 is configured to be separated from the support portion 19.

That is, by further lifting the upper unit 3 integrated with the assist mechanism 5, the upper unit 3 can be opened to the state illustrated in FIG. 3. FIG. 3 illustrates the open state in which the setting property is good when the medium 6 is set on the placement surface 11 of the lower unit 2.

### Description of Effects of First Embodiment

(1) In the present embodiment, there is provided the assist mechanism 5 that reduces the lifting weight of the upper unit 3 when the upper unit 3 is shifted from the closed state to the open state. The assist mechanism 5 includes the base portion 12 that is integrally attached to the upper unit 3, the rod-shaped arm portion 13, the rotation shaft 14 that rotatably supports the arm portion 13, the operation portion 17 that is coupled to the one end 15 of the arm portion 13, extends downward, and is movable in the vertical direction, the action portion 18 that is coupled to the other end 16 of the arm portion 13 and extends downward, and the support portion 19 that is disposed in the lower unit 2 and contacts and supports the action portion 18 from below.

Then, in the assist mechanism 5, the arm portion 13 rotates about the rotation shaft 14 as the operation portion 17 moves upward, and the action portion 18 presses the support portion 19 to lift the base portion 12 upward, so that the upper unit 3 is lifted upward with respect to the lower unit 2. That is, the assist mechanism 5 is configured to assist in lifting the upper unit 3 upward using principle of leverage.

Accordingly, with a simple configuration using principle of leverage, the upper unit 3 can be lifted and opened with respect to the lower unit 2 with small force.

(2) In addition, in the present embodiment, the upper unit 3 includes the processing unit 9 including the transport unit 7 and the first reading unit 8. That is, the center of gravity of the upper unit 3 is located closer to the portion where the processing unit 9 is disposed. Then, the assist mechanism 5 is disposed such that at least a part of the assist mechanism 5 overlaps at least a part of the processing unit 9 when viewed from the front side (+ Y side) to the rear side (- Y side). Accordingly, since the assist mechanism 5 is provided in a heavy portion of the upper unit 3, the effect of reducing a weight burden when opening the upper unit 3 is large.

(3) In addition, in the present embodiment, the operation portion 17 includes the long first rod portion 20 and the force receiving portion 22 located at the lower end 21 of the first rod portion 20 and receives the lifting force. The action portion 18 includes the long second rod portion 23 and the pressing portion 25 located at the lower end 24 of the second rod portion 23 and in contact with the support portion 19. Then, the base portion 12 includes the vertical portion 27 having the rotation shaft 14 at the upper portion 26, and the long horizontal portion 29 provided at the lower portion 28 of the vertical portion 27. Accordingly, the assist mechanism 5 that enables the upper unit 3 to be lifted upward with respect to the lower unit 2 with small force can be realized with a simple structure.

(4) In addition, in the present embodiment, the horizontal portion 29 includes the first penetration portion 30 and the second penetration portion 31, the first rod portion 20 is disposed to movably penetrate the first penetration portion 30, and the second rod portion 23 is disposed to movably penetrate the second penetration portion 31. That is, both the first rod portion 20 and the second rod portion 23 are provided so as to move in a state of penetrating the horizontal portion 29 of the base portion 12. Accordingly, a lifting operation of the upper unit 3 by the assist mechanism 5 can be stably performed.

(5) In addition, in the present embodiment, the first penetration portion 30 includes the first guide portion 32 that guides movement of the first rod portion 20 in the vertical direction. The second penetration portion 31 includes the second guide portion 33 that guides movement of the second rod portion 23 in the vertical direction. Accordingly, the first rod portion 20 and the second rod portion 23 can be stably moved with respect to the base portion 12.

(6) The upper unit 3 has the largest weight load at the initial stage of the opening operation of shifting from the closed state to the open state with respect to the lower unit 2. After the initial stage, the load decreases.

In the present embodiment, there is provided the restriction portion 34 that restricts a range in which the base portion 12 can move upward in a state where the action portion 18 is in contact with the support portion 19. Accordingly, it is possible to design so as to receive the assist by the assist mechanism 5 only in the initial stage where the load of the opening operation is large. Therefore, an increase in size of the assist mechanism 5 can be avoided.

(7) In addition, in the present embodiment, after the upper unit 3 is lifted via the assist mechanism 5, the operation portion 17 is lifted to separate the action portion 18 from the support portion 19. Accordingly, when the upper unit 3 is in the open state, since the action portion 18 is separated from the support portion 19, the upper unit 3 does not interfere with placing the medium 6 on the placement surface 11 of the lower unit 2 or the like.

(8) In addition, in the present embodiment, the operation panel 35 disposed on the front side is provided, and the operation portion 17 and the operation panel 35 are configured not to overlap each other in a plan view. Accordingly, the operation panel 35 does not interfere with an operation of lifting the operation portion 17 upward, and thus the assist mechanism 5 can be smoothly operated.

### Second Embodiment

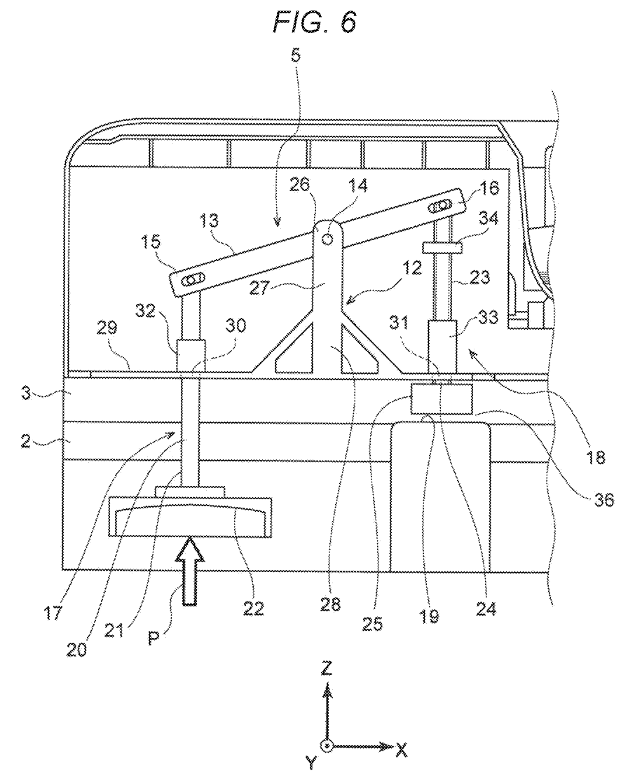

Next, an image reading apparatus 1 according to a second embodiment will be described with reference to FIG. 6. The same portions as those of the first embodiment have the same signs, and the description of the configurations and the corresponding effects thereof is omitted.

In the first embodiment, the action portion 18 and the support portion are in contact with each other in the closed state of the upper unit 3, but in the present embodiment, a gap 36 is formed between the action portion 18 and the support portion 19 in the closed state of the upper unit 3. The distance of the gap 36 is set so that the upper unit 3 does not immediately move upward even when force is carelessly applied to the operation portion 17. Here, the distance of the gap 36 is about 3 mm.

In the present embodiment, in the closed state of the upper unit 3, there is the gap 36 between the action portion 18 and the support portion 19. Accordingly, even when lifting force is carelessly applied to the operation portion 17, it is possible to prevent the upper unit 3 from being immediately opened by the gap 36. Therefore, a stable image reading operation can be realized.

### Other Embodiments

The image reading apparatus 1 according to the present disclosure is based on the configuration of the embodiment described above, and it is needless to say that the partial configuration can be changed or omitted without departing from the gist of the present disclosure.

What is claimed is:

1. An image reading apparatus comprising:
a lower unit;
an upper unit disposed above the lower unit;
a hinge disposed on one side of the lower unit and the upper unit and coupling the upper unit to the lower unit in an openable and closable manner; and
an assist mechanism disposed on the other side opposite to the one side and configured to reduce lifting weight of the upper unit when the upper unit is shifted from a closed state to an open state, wherein
the assist mechanism includes:
a base portion integrally attached to the upper unit;
an arm portion disposed in the upper unit and extending in a rod shape;
a rotation shaft being a rotation shaft provided in the base portion and rotatably supporting the arm portion at a position between one end and the other end of the arm portion;
an operation portion coupled to the one end of the arm portion, extending downward, and movable in a vertical direction;
an action portion coupled to the other end of the arm portion and extending downward; and
a support portion disposed in the lower unit and contacting and supporting the action portion from below, and
the arm portion rotates about the rotation shaft as the operation portion moves upward, and the action portion presses the support portion to lift the base portion upward, so that the upper unit is lifted upward with respect to the lower unit.

2. The image reading apparatus according to claim 1, wherein
the upper unit includes
a processing unit including: a transport unit capable of transporting a medium; and
a first reading unit configured to read an image of the medium transported by the transport unit, and
at least a part of the assist mechanism overlaps at least a part of the processing unit when viewed from the other side to the one side.

3. The image reading apparatus according to claim 1, wherein
the operation portion includes:
a long first rod portion; and
a force receiving portion located at a lower end of the first rod portion and configured to receive lifting force,
the action portion includes:
a long second rod portion; and
a pressing portion located at a lower end of the second rod portion and in contact with the support portion, and
the base portion includes:
a vertical portion including the rotation shaft at an upper portion; and
a long horizontal portion provided at a lower portion of the vertical portion.

4. The image reading apparatus according to claim 3, wherein
the horizontal portion includes a first penetration portion and a second penetration portion that are penetrated in the vertical direction,
the first rod portion is disposed to movably penetrate the first penetration portion, and the second rod portion is disposed to movably penetrate the second penetration portion.

5. The image reading apparatus according to claim 4, wherein
the first penetration portion includes a first guide portion configured to guide movement of the first rod portion in the vertical direction, and
the second penetration portion includes a second guide portion configured to guide movement of the second rod portion in the vertical direction.

6. The image reading apparatus according to claim 1, further comprising
a restriction portion configured to restrict a range in which the base portion is able to move upward in a state where the action portion is in contact with the support portion.

7. The image reading apparatus according to claim 1, wherein
the action portion is separated from the support portion by lifting the operation portion after the upper unit is lifted via the assist mechanism.

8. The image reading apparatus according to claim 1, wherein
there is a gap between the action portion and the support portion in the closed state of the upper unit.

9. The image reading apparatus according to claim 1, wherein
the lower unit includes an operation panel disposed on a front side being the other side, and
the operation portion and the operation panel do not overlap each other in a plan view.
